(19) United States
(12) Patent Application Publication
(10) Pub. No.: US 2011/0126973 A1
(43) Pub. Date: Jun. 2, 2011

(54) Apparatus And Method For Manufacturing A Honeycomb Article

(76) Inventors: Edward Francis Andrewlavage, JR., Corning, NY (US); John Deane Madison, Painted Post, NY (US); James Raymond Mudd, Lindley, NY (US); Robert Daniel Parker, Beaver Dams, NY (US); Pamela Lynn Payne, Painted Post, NY (US); John Charles Speeckaert, Painted Post, NY (US)

(21) Appl. No.: 12/851,119

(22) Filed: Aug. 5, 2010

Related U.S. Application Data
(60) Provisional application No. 61/265,083, filed on Nov. 30, 2009.

(51) Int. Cl. B32B 38/10; B32B 37/00

(52) U.S. Cl. 156/247; 156/538

(57) ABSTRACT

An apparatus and method for manufacturing a honeycomb article with an after-applied skin, where the edges of the after-applied skin are relieved with respect to the ends of the honeycomb article.

### CROSS-REFERENCE TO RELATED APPLICATION

This application claims the benefit of priority to U.S. provisional application No. 61/265,083, filed on Nov. 30, 2009.

### BACKGROUND

The present disclosure relates generally to a honeycomb article, a method of manufacturing the honeycomb article, and an apparatus for manufacturing the honeycomb article. More particularly, the disclosure relates to a method and apparatus which may be used to manufacture a honeycomb article having an after-applied skin layer that has been shaped to provide protection from chipping and flaking damage at the edges of the honeycomb structures.

No admission is made that any reference cited herein constitutes prior art. Applicant expressly reserves the right to challenge the accuracy and pertinence of any cited documents.

The use of honeycomb articles as filters for removing particulates (e.g., soot) from engine exhaust gases, and as substrates for supporting catalytic materials for purifying engine exhaust gases is well known. A particulate filter body may be, for example, a honeycomb article having a matrix of intersecting thin, porous walls that extend across and between its two opposing open end faces to form a large number of adjoining hollow channels, or cells, which also extend between the end faces. To form a filter, a portion of the cells is closed at one end face, and the remaining cells are closed at the other end face. A contaminated gas is brought under pressure to one face (the “inlet face”) and enters the filter body via the cells that are open at the inlet face (the “inlet cells”). Because the inlet cells are sealed at the opposite end face (the “outlet face”) of the body, the contaminated gas is forced through the thin, porous walls into adjoining cells that are sealed at the inlet face and open at the opposing outlet face of the filter body (the “outlet cells”). The solid particulate contaminants in the exhaust gas which are too large to pass through the porous openings in the walls are left behind, and cleaned exhaust gas exits the outlet face of the filter body through the outlet cells. A substrate for supporting catalytic materials may similarly be a honeycomb article having a matrix of intersecting walls that extend across and between its two opposing open end faces and form a large number of adjoining hollow channels, or cells, which also extend between and are open at both end faces. The walls are coated with a catalytic material selected to reduce the amount of carbon monoxide (CO), nitrogen oxides (NOx), and/or unburned hydrocarbons (HC) in the exhaust gas as the exhaust gas passes through the cells.

Such cellular honeycomb bodies are typically formed by an extrusion process where a ceramic-forming material is extruded in a green (uncured) form, and then the green form is dried and fired to form the final ceramic material of the article. The extruded green forms can be any size or shape, and generally, as a function of the extrusion process, a solid external surface, or skin, is provided along the length of the extruded form. Under certain circumstances, however, it becomes necessary to remove the external surface, or skin, from the honeycomb structure, either before or after firing of the extruded green form. For example, in some instances the honeycomb structure is reshaped to a different shape and size to meet the needs of engine manufacturers. In other cases, the extruded green forms may have sustained damage or defects at the outer peripheral portion of the form due to, for example, the weight of the honeycomb article itself causing cells in the outer peripheral portion of the form to collapse or deform, or causing cracks in the skin.

In such situations, the outer peripheral portion (e.g., the skin and one or more cell layers) of the honeycomb article may be removed, typically after drying and/or firing of the green form, so as to remove the deformed cells and/or to provide the honeycomb article with a desired size and shape. A new layer of material may then be applied using techniques known in the art to provide a new solid external surface, or skin, along the length of the article. However, the after-applied skin may sometimes be damaged in the course of handling the honeycomb articles during and after manufacture. Damage (e.g., chipping) may occur on the edges of the skin due to the mechanical stresses of contacting the edges with other surfaces, and such damage contributes to handing losses during manufacturing and throughout the supply chain.

Accordingly, providing ceramic honeycomb structures with an after-applied skin which is less susceptible to mechanical damage is desired. Likewise, methods of manufacturing ceramic honeycomb structures with after-applied skin which is less susceptible to mechanical damage are also desired.

### SUMMARY

One embodiment of the disclosure relates to a method of manufacturing a honeycomb article. In one embodiment, the method comprises fixing a honeycomb body between first and second support members, wherein a support surface of each support member includes a compressible pad having an outer edge and a contact face. At least a portion of the contact face defines an angle α with respect to the support surface, and the compressible pad is configured such that at least a portion of the angled contact face extends beyond a periphery of the honeycomb body fixed between the support members. A skin layer is applied to the honeycomb body, wherein a first edge of the skin layer contacts the angled contact face of the compressible pad on the first support member and a second edge of the skin layer contacts the angled contact face of the compressible pad on the second support member such that the first and second edges of the skin layer are relieved with respect to the first second ends, respectively.

An additional embodiment of the disclosure relates to an apparatus for manufacturing a honeycomb article. In one embodiment, the apparatus comprises first and second support members configured to hold a honeycomb body therebetween. Each support member comprises a support surface and a compressible pad on the support surface. The compressible pad has a contact face that defines an angle α with respect to the support surface. The compressible pad is configured such that at least a portion of the angled contact face extends beyond a periphery of a honeycomb body held between the support members. An applicator is configured to apply a skin layer to the honeycomb body between the first and second support members, such that the skin layer extends between the compressible pads on the support members and conforms to the portions of the angled contact faces that extend beyond the periphery of the honeycomb body.

Additional features and advantages will be set forth in the detailed description which follows, and in part will be readily apparent to those skilled in the art from the description or recognized by practicing the embodiments as described in the written description and claims hereof, as well as the appended drawings.

It is to be understood that both the foregoing general description and the following detailed description are merely exemplary, and are intended to provide an overview or framework to understand the nature and character of the claims.

The accompanying drawings are included to provide a further understanding, and are incorporated in and constitute a part of this specification. The drawings illustrate one or more embodiment(s), and together with the description serve to explain principles and operation of the various embodiments.

### BRIEF DESCRIPTION OF THE DRAWINGS

FIG. 1 is a perspective illustration of a honeycomb article fabricated using conventional methods.

FIG. 2 is a perspective illustration of a honeycomb body after the honeycomb article of FIG. 1 has been shaped and the outer skin removed.

FIG. 3 is a perspective illustration of a honeycomb article with an after-applied skin according to the present disclosure, in which edges of the skin are relieved.

FIG. 4 is a schematic illustration of a relieved edge of a honeycomb article according to the present disclosure.

FIG. 5 is a schematic illustration of an apparatus for manufacturing a honeycomb article with an after-applied skin having relieved edges according to the invention.

FIGS. 6A-6C are schematic illustrations of a portion of the apparatus of FIG. 5, showing the contact between a honeycomb body and a compressible pad during application of a skin having relieved edges.

FIGS. 7A-7B are greatly enlarged schematic illustrations of a compressible pad used to form relieved edges on an after-applied skin, showing the pad in an uncompressed condition (FIG. 7A) and compressed condition (FIG. 7B).

### DETAILED DESCRIPTION

Honeycomb articles used for solid particulate filtering, catalytic substrates, and other applications may be formed from a variety of porous materials including ceramics, glass-ceramics, glasses, metals, cements, resins or organic polymers, papers, or textile fabrics (with or without fillers, etc.), and various combinations thereof. Honeycomb articles having uniformly thin, porous and interconnected walls for solid particulate filtering applications are preferably fabricated from plastically formable and sinterable substances that yield a porous, sintered material after being fired to affect their sintering, such as metallic powders, ceramics, glass-ceramics, cements, and other ceramic-bases mixtures. According to certain embodiments, honeycomb articles may be formed from a porous ceramic material, such as cordierite, silicon carbide, or aluminum titanate.

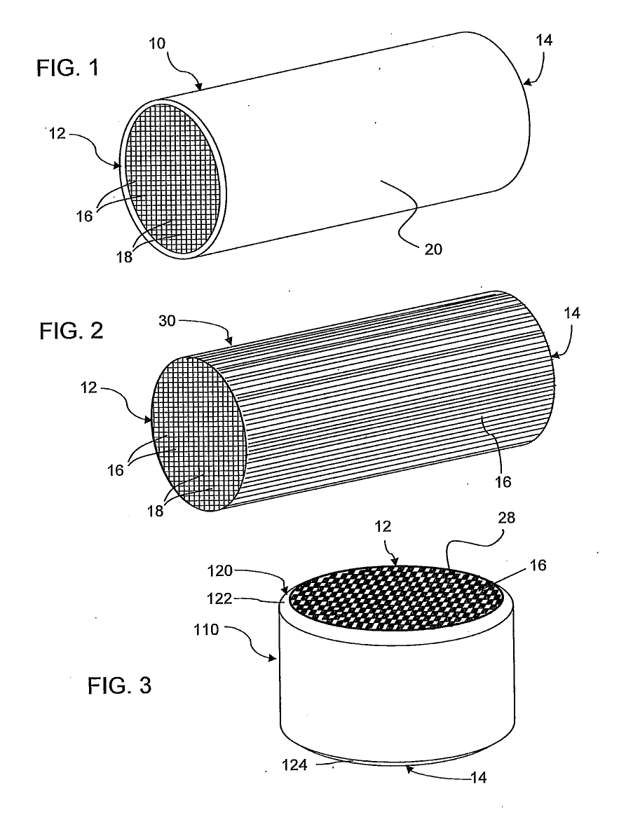

One embodiment of an extruded honeycomb article is shown in FIG. 1, and is designated generally throughout by the reference numeral 10. Honeycomb article 10 has a first end face 12, a second end face 14, and a plurality of hollow, open-ended channels or cells 16 that extend in a generally parallel fashion through honeycomb article 10 between first and second end faces 12, 14. Cells 16 are open at end faces 12, 14 of honeycomb article 10, and are formed by a matrix of intersecting walls 18 that extend between first and second end faces 12, 14. Walls 18 have physical characteristics (e.g., porosity, pore size distribution, etc.) suitable for the intended application of the honeycomb article (e.g., a filter or substrate), and may have either a uniform thickness or a non-uniform thickness, depending upon the intended application. The thickness and spacing of walls 18 are selected to provide a density of cells 16 as is desired for the intended application. In some applications, cell 16 density is in the range of 100-900 cells per square inch, although cell densities lower and higher than that range may also be used. An outer wall or skin 20 extends between first and second end faces 12, 14, bounding cells 16 and walls 18.

As used in this disclosure, the term “honeycomb article” is intended to include articles having a generally honeycomb structure and is not limited to articles with cells 16 having a generally square cross-sectional shape. For example, hexagonal, octagonal, triangular, square, rectangular, circular, oval, or any other suitable cell shape may be provided. It should be noted that in the Figures the relative dimensions of cells 16, walls 18 and skin 20 are not to scale.

As described above, in some circumstances honeycomb article 10 is contoured or shaped after it is extruded (and before or after drying and firing of the green form) so as to remove deformed cells 16 and/or to provide a desired size and shape to the contoured article. Contouring or shaping of honeycomb article 10 can be accomplished by any means known in the art, including cutting or grinding away the exterior surface or skin 20 of honeycomb article 10 until the desired shape and size is reached. The final peripheral shape of the may be any possible shape, for example, round, oval, rectangular, and the like.

FIG. 2 illustrates an embodiment of a honeycomb body 30 resulting from contouring or shaping honeycomb article 10. As used herein, the term “honeycomb body” generally refers to a honeycomb article 10 to which an after-applied skin 120 (described below) is applied. The honeycomb body 30 retains a multiplicity of cells 16 defined by walls 18. However, all or a portion of the originally extruded outer wall or skin 20 of honeycomb article 10, as shown in FIG. 1, may be removed during a shaping or contouring operation such that cells 16 located at the periphery of the shaped honeycomb body 30 are open along the length of the body 30.

Referring now to FIG. 3, after honeycomb article 10 is shaped (and optionally dried and fired), a new external skin (i.e., an after-applied skin) 120 is applied to honeycomb body 30 to form a honeycomb article 110. The after-applied skin 120 can be of any material known in the art. By way of example, the honeycomb body 30 can be comprised of cordierite, aluminum titanate, SiC, or other ceramic materials, or combinations thereof. After-applied skin 120 can comprise material that is compatible with the material of the honeycomb body 30. For example, although not required, after-applied skin 120 can comprise material that is of similar or identical composition to the material of the honeycomb body 30. In one embodiment, after-applied skin 120 is a material that is primarily cordierite, with organic and/or inorganic binder components.

Honeycomb article 110 may be configured as a flow-through substrate (such as for supporting catalytic materials selected to reduce the amount of carbon monoxide, nitrogen oxides, and/or unburned hydrocarbons in the exhaust gas as the exhaust gas passes through the cells) in which all or a majority of cells 16 remain free of obstruction, or may alternately be configured as a filter in which selected cells 16 of the honeycomb article 110 blocked. FIG. 3 illustrates a honeycomb article 110 from which a filter is formed by plugging, covering or otherwise blocking the open ends of a subset of cells 16 at first end face 12, and further blocking all or a portion of the remaining cells 16 at the opposing second end face 14. In the exemplary embodiment of FIG. 3, alternate cells 16 have been blocked with plugs 28 at first end face 12 in an exemplary checkerboard pattern. In one embodiment, the plugging pattern on second end face 14 (hidden in FIG. 3) is the reverse of that depicted on first end face 12. Alternate plugging patterns from that illustrated may be implemented in other embodiments.

Cells 16 are plugged with a suitable plugging material, such as a sealant or cement mass, which extends from near first and second end faces 12, 14 a short distance into cell 16. Plugs 28 may be formed by any means known in the art. After forming, the sealant or cement forming plugs 28 is cured by any method suitable for the particular material selected so as to form a seal that will substantially block the flow of the gas being filtered. The result is a pattern of plugs 28 arranged on the first and second (i.e., inlet and outlet) end faces 12, 14 such that contaminate laden gas (such as engine exhaust gas) flows into the filter body, into the filter cells that are not plugged at first (e.g., inlet) face 12, through the porous walls 18 of cells 16, and out of the filter body through cells 16 which are not plugged at second (e.g., outlet) face 14. As noted above, when used as flow-through substrates for supporting catalytic materials, honeycomb articles 110 typically have no plugged cells 16, or only a small number of plugged cells 16 so that a majority of the cells 16 remain unplugged at both end faces 12, 14.

It should be noted that although embodiments described herein reference the application of an after-applied skin 120 to a honeycomb body 30 from which all or a portion of the original skin 20 has been removed, the teachings of this disclosure are equally applicable to the application of an after-applied skin 120 over an existing skin 20, such as may be required to bring a honeycomb article 10 to a desired size. Accordingly, use of the term “honeycomb body” should be understood to include bodies from which all, a portion, or none of the originally extruded skin 20 has been removed.

Referring again to FIG. 3, it is shown that edges 122, 124 of after-applied skin 120 are relieved (e.g., angled or radiused) with respect to first and second end faces 12, 14. Peripheral edges 122, 124 of after-applied skin 120 may be more susceptible to damage than the honeycomb body 30 itself, and relieved edges 122, 124 reduce damage (e.g., chipping) that may occur on the edges of the skin 120 due to the mechanical stresses caused by contacting the edges 122, 124 with other surfaces. For example, as a honeycomb article 110 with an after-applied skin 120 comes into contact with a surface, or slides across a surface, edges 122, 124 of the after-applied skin 120 may break, chip or flake. This may be particularly evident as honeycomb articles 110 are manipulated by hand, and as the honeycomb articles 110 precede through the manufacturing processes of the supply chain where the honeycomb articles 110 are coated and canned for use in an exhaust system.

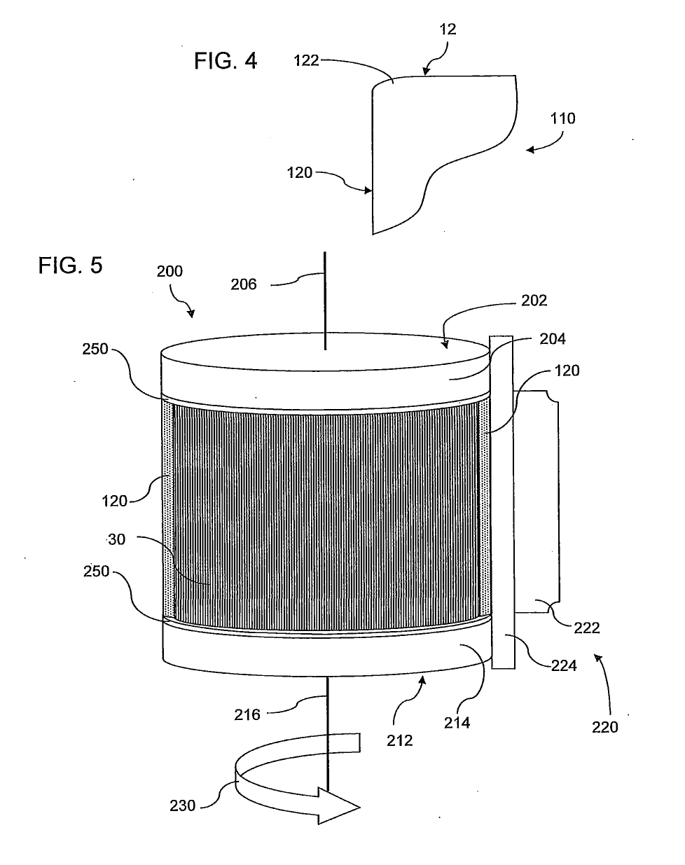

Referring to FIG. 4, relieved edges 122, 124 curve or angle away from and below the plane of adjacent edge face 12, 14, respectively. For purposes of clarity, only edge 122 adjacent end face 12 of honeycomb article 110 is illustrated in FIG. 4; edge 124 at opposite end face 14 may be similarly relieved. Preferably, relieved edges 122, 124 are formed such that little or no portion of walls 18 is exposed above edges 122, 124. In one embodiment, substantially the entire thickness of skin 120 is relieved. In another embodiment, only an outer circumferential portion of skin 120 is relieved.

FIG. 5 schematically represents an apparatus 200 for manufacturing a honeycomb article 110, and specifically for applying after-applied skin 120 to honeycomb body 30 such that skin 120 is provided with relieved edges 122, 124. The apparatus 200 may be used to apply skin 120 to a wide variety of honeycomb bodies 30, particularly honeycomb bodies 30 comprised of ceramic or ceramic-forming material(s). The honeycomb bodies 30 can be used as flow-through substrates (e.g., catalyst supports) or filters provided with alternately plugged channels as described above.

Apparatus 200 includes a first support member 202 having a lateral edge 204 and configured to rotate about a first longitudinal axis 206, and a second support member 212 having a lateral edge 214 and configured to rotate about a second longitudinal axis 216. In the illustrated embodiment, first longitudinal axis 206 and second longitudinal axis 216 are coaxial, although the first and second longitudinal axes 206, 216 may be differently aligned (e.g., parallel but not coaxial) in some applications, as is known in the art. As illustrated, first and second support members 202, 212 comprise plate-like structures, although other structural arrangements may also be used, such as hub and spoke arrangements, lattice structures, and the like. In addition, although support members 202, 212 are illustrated as having circular shapes, other shapes may be used in different embodiments. Specifically, the peripheral shape of support members 202, 212 can comprise any shape that generally conforms to the shape of a honeycomb body 30 being coated by apparatus 200, such as an oval shape, elliptical shape, and so on. As will be understood from the description below, the support members 202, 212 are larger than the honeycomb body 30, with the difference in size defining the thickness of skin 120 applied to honeycomb body 30.

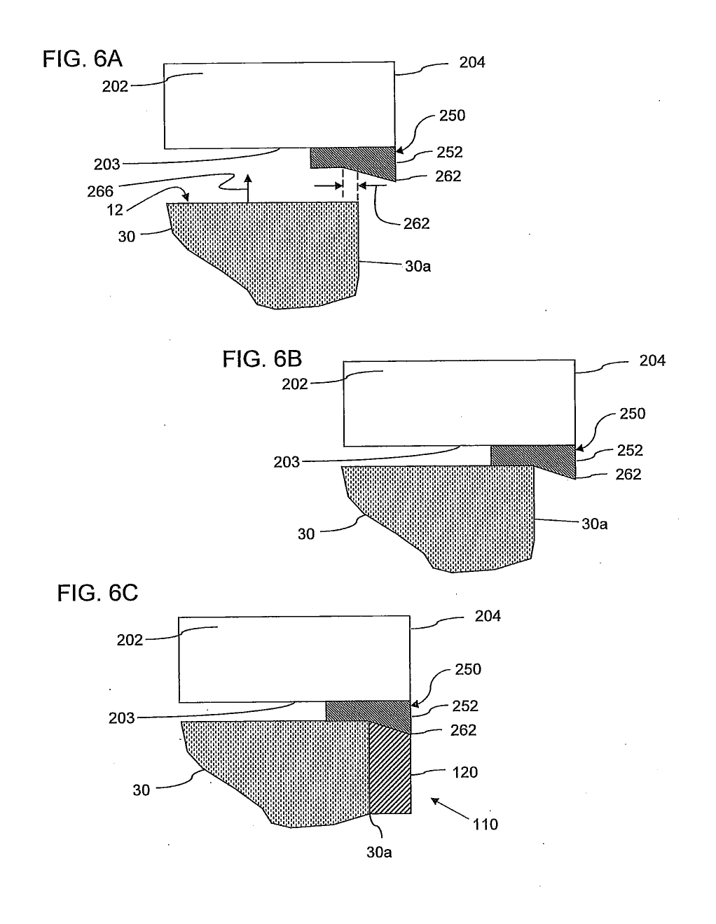

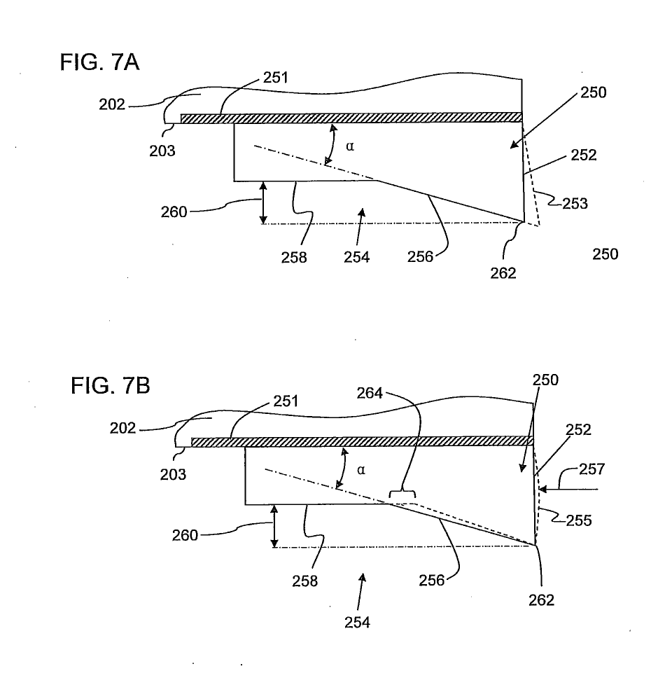

Referring to FIGS. 6A-6C (collectively “FIG. 6”) and 7A-7B (collectively “FIG. 7”), a greatly enlarged peripheral portion of support member 202 is illustrated. For clarity of understanding, the elements in FIGS. 6 and 7 are not drawn to scale and proportions of some features may be exaggerated to better illustrate the features. Only support member 202 is described in detail. However, it is to be understood that support member 212 may be similarly configured.

Support member 202 includes a compressible pad 250 on its support surface 203 (i.e., the surface supporting honeycomb body 30). Compressible pad 250 extends around the entire periphery of support member 202 (as defined by lateral edge 204), and may be directly secured to support surface 203, or may alternately be secured to support member 202 via an intermediate member 251 (FIG. 7), such as a ring onto which compressible pad 250 is cast or otherwise secured. The intermediate member 251 may be secured to support member 202 via any conventional means, such as screws, bolts, adhesive, friction fit, and the like.

Compressible pad 250 may be formed from any suitable material, such as silicone, polytetrafluoroethylene (PTFE or Teflon®), ultra high molecular weight polyethylene (UHMW), or other known materials suitable for the purpose. In one embodiment, compressible pad 250 is formed from an addition cure silicone such as, for example, Silastic® S or Silastic® V silicone rubber available from Dow Corning Corporation. The use of addition cure silicone has been found to reduce or eliminate oil contamination of the honeycomb body, which may adversely affect later honeycomb coating processes. In one embodiment, compressible pad 250 is formed from a material having a high tear resistance and a medium to low durometer, such as a durometer hardness of less than about 40 Shore A, and a tear strength of greater than about 120 die B, ppi.

Compressible pad 250 has an outer edge 252 and a contact face 254. In one embodiment, outer edge 252 of compressible pad 250 is generally aligned with lateral edge 204 of support member 202. As will be further described below, in another embodiment, compressible pad 250 may be formed such that at least a portion of outer edge 252 extends radially beyond lateral edge 204 of support member 202. The contact face 254 includes a chamfer portion 256 adjacent to the outer edge 252, and a stop portion 258 positioned laterally inward from the outer edge 252. As best seen in FIG. 6, at least a portion of the chamfer portion 256 extends beyond an outer peripheral edge 30a of honeycomb body 30 when held between the support members 202, 212, and in some embodiments substantially the entire chamfer portion 256 extends beyond the periphery 30a of honeycomb body 30. As shown in FIG. 7, chamfer portion 256 defines an angle α with respect to the support surface 203 and, in one embodiment, the angle α is in the range of about 5° to about 30°.

The plane of stop portion 258 as illustrated in FIGS. 6 and 7 is substantially parallel to the support surface 203 of the support member 202, although all or a portion of stop portion 258 may also be angled with respect to support surface 203, at an angle less than, equal to, or greater than the angle α defined by chamfer portion 256. The chamfer portion 256 and stop portion 258 of compressible pad 250 define a stop distance 260. As used herein, the stop distance 260 is the distance from the vertex 262 of the intersection of chamfer portion 256 and outer edge 252 to the plane of stop portion 258. In preferred embodiments, the stop distance 260 is in the range of about 0.010 inches to about 0.080 inches, although larger and smaller distances may be used in other embodiments.

Stop distance 260 and angle α are selected such that when skin 120 is applied, edges 122, 124 extend substantially completely to, but not beyond, the plane of end faces 12, 14, such that matrix walls 18 are not exposed. Stop distance 260 and angle α are selected in consideration of factors including, but not limited to, the size (e.g., diameter and height) of honeycomb body 30, the materials of honeycomb body 30 and skin 120, whether or not honeycomb body 30 includes plugged cells 16 at its periphery, the adhesion between skin 120 and honeycomb body 30, the adhesion between skin 120 and compressible pad 250, the presence or absence of plugs in the matrix of honeycomb body 30, the density of cells 16, the thickness of cell walls 18, and the compressibility (e.g., durometer) of pads 250.

If angle α is too shallow and/or stop distance 260 is too small, the skin 120 at edges 122, 124 may extend above end faces 12, 14, while if angle α is too steep and/or stop distance 260 is too large, edges 122, 124 may not extend fully to end faces 12, 14, thereby leaving portions of walls 18 exposed at peripheral edge 30a of honeycomb body 30.

While not wanting to be bound by theory, it is understood by the inventors that when honeycomb body 30 includes substantially no plugged cells 16 at its periphery (i.e., honeycomb body 30 is configured for use as a flow-through substrate), a larger angle α in combination with a larger stop distance 260 (as compared to a similarly sized honeycomb body configured for use as a filter) provides improved sealing between pad 250 and honeycomb body 30 to reduce the intrusion of wet skin material into open cells 16 near peripheral edge 30a of honeycomb body 30. For example, for embodiments in which honeycomb body 30 includes plugged cells 16 at its periphery (i.e., honeycomb body 30 is configured for use as a filter), it has been found by the applicants that angle α may be selected to be in the range of about 15°±2°, with a stop distance of about 0.03±0.01 inches. Similarly, for embodiments in which honeycomb body 30 includes substantially no plugged cells 16 at its periphery (i.e., honeycomb body 30 is configured for use as a flow-through substrate), angle α may be selected to be in the range of about 20°±2°, with a stop distance of about 0.06±0.01 inches.

Referring again to FIG. 5, when apparatus 200 is in use, honeycomb body 30 is fixed between first and second support members 202, 212, and more specifically between compressible pads 250 on support members 202, 212, by compressing honeycomb body 30 between support members 202, 212. As illustrated in FIGS. 6A-6C, honeycomb body 30 is positioned such an outer peripheral portion of end face 12 (and similarly of end face 14) overlaps a portion 264 of chamfer portion 256 (FIG. 6A). As honeycomb body 30 and support member 202 are brought together in the direction of arrow 266, overlap portion 264 is contacted by honeycomb body 30 and then compressed and deformed until end face 12 is in contact with stop portion 258 (FIG. 6B). Depending upon the compression force applied, some additional compression of stop portion 258 may occur. As pad 250 in general, and overlap portion 264 in particular is compressed, the angle α of chamfer portion 256 extending beyond peripheral edge 30a changes, and generally becomes larger (dashed line 255 in FIG. 7B). In addition, outer edge 252 is caused to bulge outwardly beyond lateral edge 204 of support member 202. As will be explained in greater detail below, during application of the skin 120 and subsequent decompression of pad 250, these effects are reversed to provide a beneficial result.

Once compressed (FIG. 6B), the position of honeycomb body 30 is maintained by friction between the faces 12, 14 of honeycomb body 30 and compressible pads 250. When fixed in this manner, the periphery 30a of honeycomb body 30 is recessed with respect to the peripheral edges 204, 214 of first and second support members 202, 212, respectively, and also with respect to some or all of chamfer portions 256 of compressible pads 250.

As seen in FIG. 5, apparatus 200 further includes an applicator 220 configured to apply skin layer 120 to the outer peripheral surface of honeycomb body 30. Applicator 220 can be configured to apply the material of skin layer 120 in a variety of ways, as are known in the art. For example, applicator 220 may include a nozzle 222 or other material dispensing device, and a knife or blade 224. The blade 224 is configured to simultaneously engage the lateral edges 204, 214 of support members 202, 212, respectively, as well as outer edge 252 of compressible pads 250, when applying the material of skin 120 to the outer surface of honeycomb body 30. As shown, first support member 202, second support member 212, and honeycomb body 30 fixed therebetween are rotated together in the direction of arrow 230 with respect to the applicator 220. In another embodiment, applicator 220 can be designed to rotate while support members 202, 212 and honeycomb body 30 remain stationary.

As will be understood by those of skill in the art, wet ceramic material is deformable. The term “wet” for the purposes of this disclosure, means a material that has not been fired, dried, sintered, calcined or otherwise exposed to a treatment which causes the material to harden. Thus, as applicator 220 dispenses wet material to form skin 120 and blade 224 simultaneously engages the lateral edges 204, 214 of support members 202, 212, respectively, the wet skin material is deformed and spread over honeycomb body 30 so as to be maintained in the space between blade 224, honeycomb body 30, and chamfer portions 256 of compressible pads 250 on first and second support members 202, 212. A skin 120 of substantially uniform thickness and having an outer peripheral shape matching that of peripheral edges 204, 214, and having relieved edges 122, 124 is thus formed.

As described above, in some embodiments, compression of pad 250 causes the outer edge 252 of the pad 250 to bulge outwardly beyond lateral edge 204 of support member 202. Dashed line 255 in FIG. 7B illustrates the general shape of pad 250 when compressed against honeycomb body 30 (not shown in FIG. 7B). When this occurs, as blade 224 moves against the lateral edge 204, the bulging portion of outer edge 252 is momentarily pressed in the direction of arrow 257 by blade 224 back into skin 120 and then released as blade 224 passes, causing at least some of chamfer portion 256 (i.e., adjacent vertex 262) to peel away and release from skin 120 as the pressure of blade 224 is removed. This movement of chamfer portion 256 into skin 120 and subsequently peeling away from skin 120 provides at least part of the relief to edges 122, 124 of skin 120. In some embodiments, the amount of movement of chamfer portion 256 into and then away from skin 120 with the passing of blade 224 may be increased by forming compressible pad 250 such that outer edge 252 is provided with an exaggerated out-taper that extends radially beyond lateral edge of the associated support member 202 or 212 even when pad 250 is in an uncompressed condition. An exemplary out-taper of outer edge 252 is illustrated by dashed line 253 in FIG. 7A.

Because the deflection of chamfer portion 256 into and then away from skin 120 occurs in a peeling manner (rather than chamfer portion 256 and skin 120 being separated by pulling apart in a direction orthogonal to their mating surfaces), the occurrence of pull residue on edges 122, 124 of skin 120 is reduced or eliminated. As used herein “pull residue” refers to artifacts at the edges 122, 124 of skin 120 resulting when wet material of skin 120 sticks to pads 250 and deforms when pads 250 are pulled away. In most instances, excessive pull residue must be removed by further processing steps, including cutting, smoothing, grinding or polishing, or any other technique or combination of techniques well known in the art.

After skin 120 is formed on honeycomb body 30, the honeycomb article 110 is removed from apparatus 200, and from contact with compressible pads 250, in particular. As the compression force between honeycomb body 30 and pads 250 is removed, the deflection of pads 250 is reversed, and overlap portion 264 is decompressed, thereby allowing chamfer portion 256 to return to its original angle α. As overlap portions 264 are decompressed, the decompressing section of chamfer portion 256 is peeled from the skin 120 in a radially outward direction, which imparts the relieved shape to edge 122, 124, as illustrated in FIG. 4. In addition, as noted above, because the separation of chamfer portion 256 from skin 120 occurs in a peeling manner, the occurrence of pull residue on edges 122, 124 of skin 120 is reduced or eliminated.

In some instances, it may be desired or necessary to further reduce the occurrence and/or severity of pull residue at edges 122, 124. Therefore, in some embodiments, at least edges 122, 124 of skin 120 may be dried or partially dried, such as by localized heating, prior to removing the honeycomb article 110 from contact with compressible pads 250. At least partially drying (e.g., such as by heating) edges 122, 124 reduces the adhesion of the wet skin material to pads 250, such that pull residue on edges 122, 124 of skin 120 is reduced or eliminated when honeycomb article 110 is removed from support members 202, 212. More specifically, drying or partially drying the wet material by heating at one or both of edges 122, 124 results in a high cohesive strength in the material and a high adhesive force between the dried edges 122, 124 and the underlying matrix of honeycomb body 30, thereby overcoming the adhesive force between skin 120 and pads 250 and providing smooth edges 122, 124 on skin 120. Heating can be accomplished using any of a wide variety of heat sources, as are known in the art, such as a directed flow of heated air, radiant heating, or indirect heating through support members 202, 212

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that any particular order be inferred.

It will be apparent to those skilled in the art that various modifications and variations can be made without departing from the spirit or scope of the invention. Since modifications combinations, sub-combinations and variations of the disclosed embodiments incorporating the spirit and substance of the invention may occur to persons skilled in the art, the invention should be construed to include everything within the scope of the appended claims and their equivalents.

What is claimed is:

1. A method of manufacturing a honeycomb article, the method comprising:
fixing a honeycomb body having a first end and a second end between a first support member and a second support member, the first support member positioned against the first end of the honeycomb body and the second support member positioned against the second end of the honeycomb body, wherein a support surface of each support member includes a compressible pad having an outer edge and a contact face, at least a portion of the contact face defining an angle α with respect to the support surface such that a distance between the contact face and the support surface increases adjacent the outer edge, and wherein the compressible pad is configured such that at least a portion of the angled contact face extends beyond a periphery of the honeycomb body fixed between the support members; and
applying a skin layer to the honeycomb body, wherein a first edge of the skin layer contacts the angled contact face of the compressible pad on the first support member and a second edge of the skin layer contacts the angled contact face of the compressible pad on the second support member such that the first and second edges of the skin layer are relieved with respect to the first second ends, respectively; and
removing the honeycomb body with the applied skin layer from between the first and second support members.

2. The method of claim 1, wherein the contact face of each compressible pad comprises a chamfer portion adjacent the outer edge and a stop portion positioned laterally inward from the outer edge, wherein the stop portion of the contact face is substantially parallel with the support surface of the support member and the chamfer portion defines an angle α with respect to the support surface, and wherein fixing the honeycomb body between the first and second support members comprises positioning the honeycomb body such that a majority of the chamfer portion extends beyond a periphery of the honeycomb body.

3. The method of claim 2, wherein fixing the honeycomb body between the first and second support members comprises positioning the honeycomb body such that substantially the entire chamfer portion extends beyond a periphery of a honeycomb body held between the support members.

4. The method of claim 1, wherein the contact face is provided with an angle α in the range of about 5° to about 30°.

5. The method of claim 2, wherein a plane defined by the stop portion is located a predetermined stop distance from a vertex defined by the intersection of the chamfer portion and the outer edge of the compressible pad, and wherein the predetermined stop distance is in the range of about 0.010 inches to about 0.080 inches.

6. The method of claim 5, wherein when the honeycomb body includes plugged cells at its periphery, the chamfer portion of the compressible pad defines an angle α of about 15°±2°, and the stop distance is about 0.03±0.01 inches.

7. The method of claim 5, wherein when the honeycomb body has substantially no plugged cells at its periphery, the chamfer portion of the compressible pad defines an angle α of about 20°±2°, and the stop distance is about 0.06±0.01 inches.

8. An apparatus for manufacturing a honeycomb article, the apparatus comprising:
a first support member and an opposed second support member, the first and second support members configured to hold a honeycomb body therebetween, wherein each support member comprises a support surface and lateral edge defining a periphery of the support surface;
a compressible pad on the support surface of each support member, the compressible pad having an outer edge and a contact face, wherein the outer edge is aligned with the lateral edge of the support member and the contact face adjacent the outer edge defines an angle α with respect to the support surface such that a distance between the contact face and the support surface increases adjacent the outer edge, and wherein the compressible pad is configured such that at least a portion of the angled contact face adjacent the outer edge extends beyond a periphery of a honeycomb body held between the support members; and
an applicator configured to apply a skin layer to the honeycomb body between the first and second support members, such that the skin layer extends between the compressible pads on the support members and conforms to the portions of the angled contact faces that extend beyond the periphery of the honeycomb body.

9. The apparatus of claim 8, wherein the angle α is in the range of about 5° to about 30°.

10. The apparatus of claim 8, wherein the contact face of each compressible pad comprises a chamfer portion adjacent the outer edge and a stop portion positioned laterally inward from the outer edge, wherein the stop portion of the contact face is substantially parallel with the support surface of the support member and the chamfer portion defines an angle α with respect to the support surface.

11. The apparatus of claim 10, wherein a plane defined by the stop portion is located a predetermined stop distance from a vertex defined by the intersection of the chamfer portion and the outer edge of the compressible pad, and wherein the predetermined stop distance is in the range of about 0.010 inches to about 0.080 inches.

12. The apparatus of claim 11, wherein when the honeycomb body includes plugged cells at its periphery, the chamfer portion defines an angle α of about 15°±2°, and the stop distance is about 0.03±0.01 inches.

13. The apparatus of claim 11, wherein when the honeycomb body has substantially no plugged cells at its periphery, the chamfer portion defines an angle α of about 20°±2°, and the stop distance is about 0.06±0.01 inches

14. The apparatus of claim 10, wherein a majority of the chamfer portion extends beyond a periphery of a honeycomb body held between the support members.

15. The apparatus of claim 14, wherein substantially the entire chamfer portion extends beyond a periphery of a honeycomb body held between the support members.

16. The apparatus of claim 8, wherein the compressible pad comprises an addition cure silicone.

17. The apparatus of claim 8, wherein the compressible pad comprises a material having a durometer hardness of less than about 40 Shore A.
